(19) United States
(12) Patent Application Publication
(10) Pub. No.: US 2004/0194814 A1
(43) Pub. Date: Oct. 7, 2004

(54) Apparatus and process for stripping resist

(75) Inventor: Norio Nishimura, Ibaraki-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co., Ltd., Kadoma-shi (JP)

(21) Appl. No.: 10/817,813

(22) Filed: Apr. 6, 2004

(30) Foreign Application Priority Data
Apr. 7, 2003 (JP) 2003-102621
Mar. 10, 2004 (JP) 2004-066455

(51) Int. Cl. B08B 3/02

(52) U.S. Cl. 134/32; 134/25.4; 134/33; 134/148; 134/153; 134/902

(57) ABSTRACT

A resist stripping apparatus is provided for cleaning a plurality of semiconductor substrates using a wafer cassette that can hold the plurality of semiconductor substrates. The apparatus includes a stripping bath capable of completely immersing the wafer cassette holding the semiconductor substrates, a unit for feeding a substitute liquid for replacing a resist stripping chemical therewith, a unit for discharging the substitute liquid, and at least one chemical high pressure spray nozzle for jetting the substitute liquid under high pressure to the semiconductor substrates.

### BACKGROUND OF THE INVENTION

1. Field of the Invention

The present invention relates to a process and an apparatus for stripping resist on a substrate for semiconductor or liquid crystal, especially on a compound semiconductor substrate made of GaAs or the like as a semiconductor substrate and cleaning the substrate.

2. Description of the Related Art

FIG. 4 is a schematic view showing the most general organic resist stripping apparatus that has been conventionally employed (see, for example, JP-A 01-175236 (1989)). A conventional organic resist stripping apparatus, as shown in FIG. 4, includes a loader 111 for loading wafer cassettes 100 accommodating substrates for semiconductor or liquid crystal, or wafers thereon, an organic resist stripping immersion bath 112, a primary IPA (isopropyl alcohol) immersion replacement bath 103, a final IPA immersion replacement bath 104, sway elevators 150, 151 and 152 provided to the respective baths, and each used for loading and swaying a wafer cassette 100, aback surface cleaning wafer chuck 105 for cleaning a back surface of each wafer, a spin chuck 106 with a rotation mechanism for cleaning each wafer, and an unloader 116 placing the wafers after cleaning in the wafer cassette and unloading the wafers in the cassette. While adopted in the description are the two IPA (isopropyl alcohol) immersion replacement baths 103 and 104 for replacing a chemical, a single bath or at least two baths, instead, can be adopted with the same basic effect.

Then, description will be given of a process for stripping and removing organic resist with a film thickness of 7 μm to 23 μm on a compound semiconductor wafer (substrate). Wafers on each of which thick film organic resist is formed shown in FIG. 4 are transferred in a state being accommodated in the wafer cassette 100 from the loader 111 shown in FIG. 4 and immersed into the organic resist stripping immersion bath 112. In the organic resist stripping immersion bath 112, an organic resist stripping liquid (a mixture composed of 60% of dimethyl sulfoxide and 40% of N-methyl-2-pyrrolidinone as main components) infiltrate into the resist G on each wafer F during immersion and the resist G is partially stripped from the wafer by swelling thereof as shown in FIG. 5.

The wafers F are, in succession, immersed into the primary IPA (isopropyl alcohol) immersion replacement bath 103, where the organic resist stripping liquid is replaced with IPA, and further immersed into the final IPA (isopropyl alcohol) immersion replacement bath 104, where the stripping liquid is replaced as the final step with IPA. Organic resist reattached on a back surface of each wafer, which cannot be removed in the replacement steps of the IPA (isopropyl alcohol) immersion replacement baths 103 and 104, is washed with an IPA rinse liquid discharged from an IPA rinse nozzle e in a state where the wafer is fixed at both end portions by the a back surface cleaning wafer chuck 105 for cleaning a back surface of each wafer; and further, each wafer is vacuum fixed on a top rotary portion of the spin chuck 106 with a rotation mechanism in a single wafer processing mode and an IPA high pressure spray nozzle f is reciprocated between positions g and g′ to thereby remove the organic resist reattached on the front surface of the wafer, followed by drying the wafer. Each wafer for which resist removal and drying following thereto have been completed is transferred to the unloader 116, in which a series of steps in the organic resist stripping process has been made.

In this context, an overall throughput of the organic resist stripping process is rate-determined by a processing time in cleaning of a back surface of each wafer by the back surface cleaning wafer chuck 105 provided with the IPA rinse nozzle e, and cleaning of the front surface of the wafer by the spin chuck 106 with a rotation mechanism, equipped with the IPA high pressure nozzle f, in both of which steps a single wafer processing mode is adopted as compared with a batch processing mode adopted in the organic resist stripping immersion bath 112, the primary IPA (isopropyl alcohol) immersion replacement bath 103 and the final IPA (isopropyl alcohol) immersion replacement bath 104, which has led to a problem that the overall processing capability of the apparatus is reduced. On the other hand, if a processing capability in the cleaning steps each with a resist removing mechanism in a single wafer processing mode is caused to match the processing capability in the baths preceding the cleaning steps, the back surface cleaning wafer chuck 105 for removing resist on the back surface of a wafer and the spin chuck 106 with a rotation mechanism for removing resist on the front surface of the wafer have to be installed to be many in number, leading to requirement for a larger installation space for the apparatus and a considerable amount of investment thereon.

### SUMMARY OF THE INVENTION

It is an object of the present invention to provide an organic resist stripping apparatus and an organic resist stripping process, by which processing capability is improved and the installation space is reduced, while realizing an organic resist stripping performance equal to that of a conventional apparatus.

In order to achieve the object, a resist stripping apparatus of the present invention includes a substrate holding vessel capable of holding a plurality of substrates, a stripping bath for accommodating the substrate holding vessel, a chemical feed unit for feeding a chemical to the stripping bath, a chemical discharge unit for discharging the chemical from the stripping bath, and at least one chemical spray nozzle for jetting the chemical to the substrates held in the substrate holding vessel.

With the above configuration, there may be provided a substrate rotating unit for rotating the substrates held in the substrate holding vessel. It is more preferable that the chemical spray nozzle jets the chemical to the substrates under high pressure and can move over the plurality of substrates held in the substrate holding vessel.

The resist stripping process of the present invention includes the steps of accommodating in a stripping bath a substrate holding vessel holding a plurality of substrates, feeding a resist stripping chemical to the stripping bath to immerse the substrate holding vessel and the substrates therein, discharging the chemical from the stripping bath, and jetting the chemical to the substrates through a chemical spray nozzle.

According to the resist stripping apparatus of the present invention, since stripping the resist on the plurality of substrates held in the substrate holding vessel is performed in a batch processing mode, no great reduction in processing capability (facility capability) is caused by rate determination of a processing time performed in a single wafer processing mode. Thus, the processing capability (facility capability) is largely improved due to the collective processing of the present invention, as an advantage provided by the batch processing mode. The resist stripping capability can provide an effect equal to that of the single wafer processing mode, in the batch processing mode adopted in the substitute liquid replacement processing.

Further, in a conventional process, there arose a necessity for installation of a multiplicity of back rinse wafer fixing chucks and rotation mechanisms each having a chemical high pressure spray. Whereas, in the resist stripping process of the present invention, it is enough to install just a single piece of equipment, thus exerting an excellent effect such as to largely reduce the installation space for the entire apparatus.

### BRIEF DESCRIPTION OF THE DRAWINGS

FIG. 1 is a schematic view showing an organic resist stripping apparatus of the present invention;

FIG. 2 is a sectional view of a main part of the organic resist stripping apparatus of the present invention;

FIG. 3 is a sectional view of a main part of a stripping bath in the organic resist stripping apparatus of the present invention;

FIG. 4 is a schematic view of a conventional organic resist stripping apparatus; and

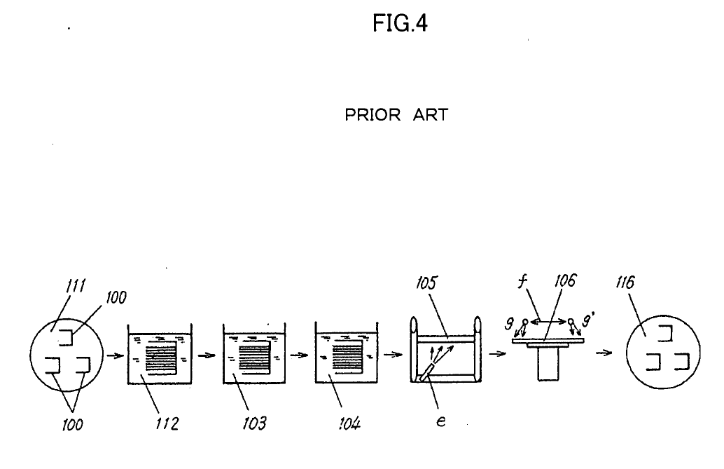

FIG. 5 is a schematic sectional view showing a state of partly stripped resist on a wafer having resist thereon.

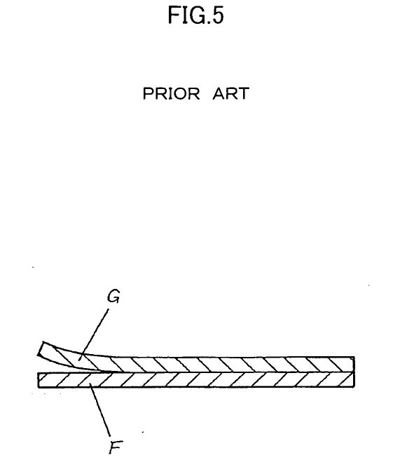

### DESCRIPTION OF THE PREFERRED EMBODIMENTS

Description will be given of embodiments of the present invention below with reference to the accompanying drawings.

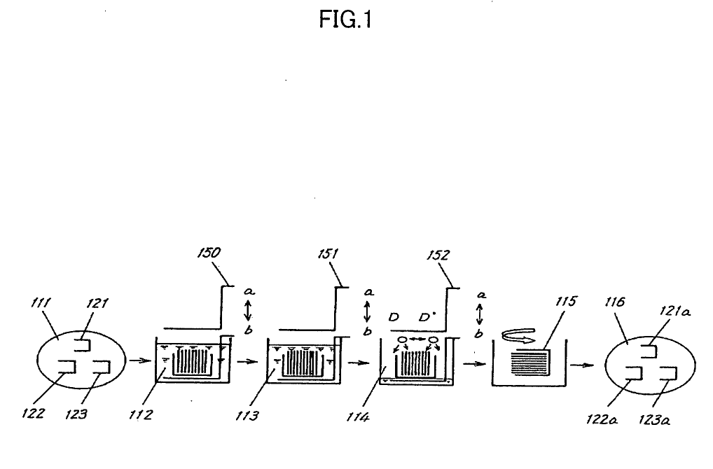

FIG. 1 shows a resist stripping apparatus of an embodiment of the present invention.

In FIG. 1, the organic resist stripping apparatus of the present invention, in description of which substrates for semiconductor or liquid crystal are semiconductor substrates, includes a loader 111 setting cassettes 121, 122 and 123 thereon that are substrate holding vessels in which wafers of semiconductor substrates are accommodated, an organic resist stripping immersion bath 112 in which the cassettes 121, 122 and 123 in which the wafers are accommodated are immersed in a stripping chemical for organic resist, a chemical immersion replacement bath 113 replacing the stripping chemical with a substitute liquid, a resist stripping compound bath 114 removing the organic resist from the wafers, replacing with the substitute liquid and cleaning the wafers, sway elevators 150, 151 and 152 disposed for the respective baths, a spin drier 115 drying the cleaned wafers, and an unloader 116 placing the wafers after processing into post-processing cassettes 121a, 122a and 123a (may be the same as the pre-processing cassettes 121, 122 and 123).

In the organic resist stripping immersion bath 112, an organic resist stripping liquid as a chemical in which the wafers are immersed contains a mixture containing 60% of dimethyl sulfoxide and 40% of N-methyl-2-pyrrolidinone as main components. A chemical as a substitute liquid for the organic resist stripping liquid in the chemical immersion replacement bath 113 and the resist stripping compound bath 114 is IPA, (isopropyl alcohol), pure water or the like, among which the most general is IPA.

Then, description will be given of a stripping and cleaning process for a semiconductor wafer using the organic resist stripping apparatus.

The cassettes 121, 122 and 123 in which wafers each with organic resist coated thereon are set on the loader 111 manually or automatically. Then, one cassette (in the description, the cassette 121 is handled) of the cassettes 121, 122 and 123 to be handled by the loader 111 using a robot arm (not shown) for cassette transfer is set on the sway elevator 150 having moved to an upper limit position a outside the organic resist stripping immersion bath 112 into which an organic resist stripping liquid has been put. The sway elevator 150 on which the cassette 121 has been set moves down to a lower limit position b in the chemical and performs sway of the cassette 121 when reaching to the lower limit position b. The organic resist stripping liquid as a chemical in which the wafers are immersed is a mixture composed of 60% of dimethyl sulfoxide and 40% of N-methyl-2-pyrrolidinone.

Stripping is performed by sway for several minutes and, thereafter, the sway elevator 150 moves to the upper limit position a and the cassette 121 is set, by a robot arm for cassette transfer, on the sway elevator 151 having moved to the upper limit position a outside the primary chemical immersion replacement bath 113 in the subsequent step. The cassette 121 to be processed moves to the lower limit position b and receives sway performed by the sway elevator 151 when reaching to the lower limit position b. The chemical as the substitute liquid for the organic resist stripping liquid is IPA, pure water or the like, among which the most general is IPA.

Replacement processing is performed by sway for several minutes and, thereafter, the sway elevator 151 moves to the upper limit position a and the cassette 121 for which the replacement has been performed is transferred by a robot arm for cassette transfer to the resist stripping compound bath 114 for the subsequent step. In the resist stripping compound bath 114 as well, the chemical as the substitute liquid for the organic resist stripping liquid is IPA, pure water or the like, among which the most general is IPA.

Description will be given of details of a construction of the resist stripping compound bath 114.

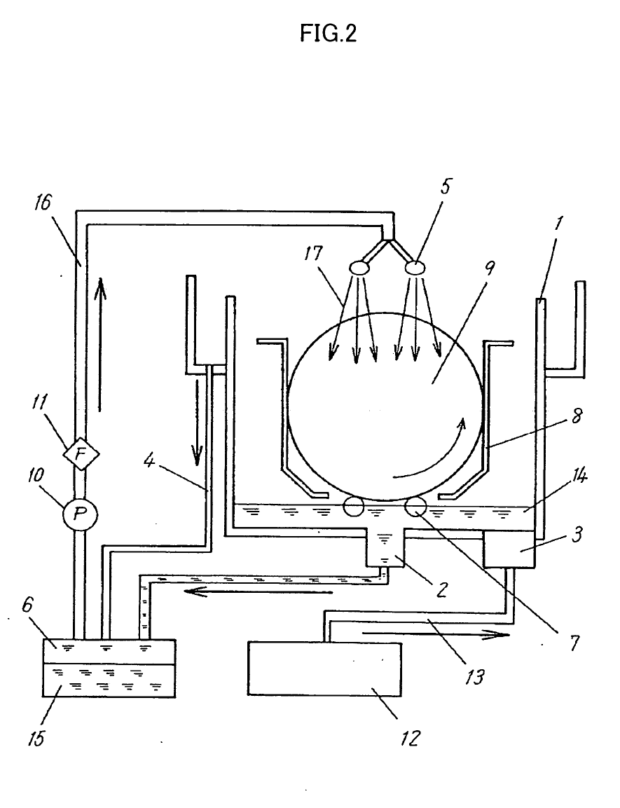

FIG. 2 shows the resist stripping compound bath 114 of the present invention.

The resist stripping compound bath 114 includes a stripping bath (main body) 1 removing the organic resist on the wafers with the substitute liquid, which is a chemical, replacing with the substitute liquid and cleaning the wafer, a chemical discharge port 2 discharging the substitute liquid from the stripping bath 1, a chemical feed port 3 feeding the substitute liquid to the stripping bath 1, a chemical return mechanism 4 equipped with a mechanism discharging the substitute liquid overflowing from the stripping bath 1, at least one chemical high pressure spray nozzle 5 for removing the organic resist and the reattached organic resist, a chemical waste buffer tank 6 storing a waste liquid from the chemical discharge port 2 and the chemical return mechanism 4, wafer rotation rollers 7 rotating a plurality of wafers 9 accommodated in a wafer cassette 8, a chemical feed high pressure pump 10 feeding the substitute liquid to the chemical high pressure spray nozzle 5 from the chemical waste buffer tank 6, a dust trap mesh filter 11 eliminating dust from the substitute liquid, and a chemical supply source 12 feeding the substitute liquid to the chemical feed port 3 through a chemical feed pipe 13.

Functions of the constituent components are as follows: the substitute liquid in the chemical supply source 12 is fed to the stripping bath 1 through a chemical feed pipe 13 and through the chemical feed port 3; when the stripping bath 1 is filled with the substitute liquid to the brim thereof, the substitute liquid flows over into the chemical return mechanism 4; and the substitute liquid flows through the pipe and is stored into the chemical waste buffer tank 6. The stored substitute liquid is reused. The substitute liquid stored in the chemical waste buffer tank 6 is fed for reuse to the chemical high pressure spray nozzle 5 for removing the organic resist and the reattached organic resist through the dust trap mesh filter 11 from the chemical waste buffer tank 6 with the chemical feed high pressure pump 10.

In the stripping bath 1, similar to the organic resist stripping immersion bath 112, the plurality of wafers 9 set in the wafer cassette 8 are processed simultaneously. The wafers 9 set in the wafer cassette 8 are rotated by the wafer rotation rollers 7 which are brought into contact with the wafers 9 from below the wafer cassette 8. The substitute liquid is jetted under high pressure to the front and back surfaces of the wafers 9 and the wafer cassette 8 from the chemical high pressure spray nozzle 5 reciprocating over the wafers 9, thereby enabling the wafers 9 and the wafer cassette 8 to be washed simultaneously.

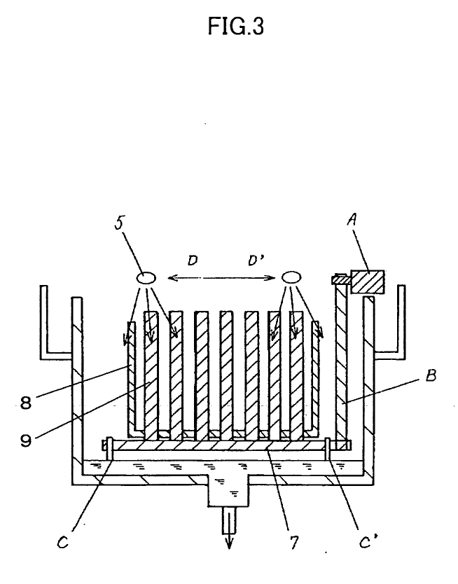

In FIG. 3, there is shown a schematic view of the stripping bath 1.

The stripping bath 1, as shown in FIG. 3, includes a mechanism holding the plurality of wafers 9 set in the cassette 8 as they are, and a mechanism for rotating the wafers 9 without taking them out from the wafer cassette 8.

With this configuration, the stripping bath 1 includes the wafer rotating rollers 7 supporting the wafer cassette 8 in which the plurality of wafers 9 are set and rotating the wafers 9 set in the wafer cassette 8, wafer rotation roller support members C and C′ supporting the wafer rotating rollers 7, a rotation motor A rotating the wafer rotation rollers 7 with the help of a rotation driving transmission belt B inserted therebetween, and the at least one chemical high pressure spray nozzle 5 reciprocating in a movement range D-D′ over the wafers 9 set in the wafer cassette 8.

Functions of the constituent components are as follows: a rotational movement of the stepping type rotation motor A is transmitted to the wafer rotation rollers 7 supported by the wafer rotation rollers support members C and C′ through the rotation driving transmission belt B, and the wafers 9 are rotated while being set in the wafer cassette 8.

Then, description will be given of a stripping method for the organic resist on the semiconductor substrates and a cleaning method for the semiconductor wafers in the resist stripping compound bath 114. In FIG. 1, the cassette 121 processed in the preceding step is transferred on the sway elevator 152 associated with the resist stripping compound bath 114 having moved to the upper limit position a.

The vertical sway elevator 152 on which the wafer cassette 8 (processing cassette 121) is placed is moved into the stripping bath 1 filled with the new substitute liquid 14 fed through the chemical feed pipe 13 and through the chemical feed port 3 from the chemical supply source 12 as shown in FIG. 2 at the lower limit position b. The wafer rotation rollers 7 starts rotation when the processing cassette 121 reaches the lower limit position b and the wafers 9 are thereby brought into contact with the wafer rotation rollers 7, the wafers 9 are rotated by the wafer rotation rollers 7 in the wafer cassette 8. By rotating the wafers 9 for several minutes, the resist stripping liquid remaining on the wafers 9 and the resist stripping liquid attached to the wafer cassette 8 are replaced with the substitute liquid 14 such as a new IPA liquid or the like to thereby clean the wafer cassette 8.

Thereafter, all the substitute liquid 14 in the stripping bath 1 is discharged through the chemical discharge port 2 while the wafers 9 are rotated, and the discharged chemical waste 15 is collected in the chemical waste buffer tank 6. The chemical waste 15 collected into the chemical waste buffer tank 6 is simultaneously drawn up by the chemical feed high pressure pump 10 and fed to the chemical high pressure spray nozzle 5 as the reused chemical 17 through the dust trap mesh filter 11 and through the reuse chemical pipe 16.

In order that the reused chemical 17 is jetted from the chemical high pressure spray nozzle 5 onto both of the front and back surfaces of the rotating wafers 9 and, also, is sprayed uniformly over all of the wafers 9, the chemical high pressure spray nozzle 5 reciprocates between the positions D and D′ as shown in FIG. 3 to perform removal of the remaining resist and the reattached resist on both of the front and back surfaces of the wafers 9. Rotation of the wafers 9 continues till the wafer cassette 8 is transported out after having been put in. A rotational speed thereof is variably adjusted by a mechanism with a function equipped to the bath and capable of varying the speed. The chemical high pressure spray nozzle 5 is mounted to the bath in parallel to the wafers 9 and a chemical jet angle is adjusted so as to be panned like a fan over both of the front and back surfaces of the wafers 9 aiming there at and the reciprocating movement (moving speed) is variable using a stepping motor.

After the stripping processing on the resist in the stripping bath 1 ends, the vertical sway elevator 152 moves to the upper limit position a, the processed cassette 121 (wafer cassette 8) is transferred to a spin dryer 115 in the subsequent step, and the wafers 9 are dried by spin rotation. In succession, the cassette 121 after drying is transferred to the unloader 116. Thereafter, the cassette 121 having been processed manually or automatically is taken out.

While a stripping apparatus and stripping process for resist of the present invention is useful especially for wafers each with thick resist in the range of 7 μm to 23 μm in film thickness such as a compound semiconductor substrate, the apparatus and process are also useful in a case where resist is stripped and removed from substrates on which resist is coated in addition to a silicon semiconductor substrate and a compound semiconductor substrate.

With the above configuration adopted, a plurality of (2 to 25 pieces as standards) wafers 9 set in the wafer cassette 8 (cassette 121) as a unit, can be subjected to stripping of resist on and cleaning both of the front and back surfaces of the wafers 9. Therefore, a processing capability is greatly improved as compared with a conventional single wafer mode process. Furthermore, an installation space for the apparatus can be greatly reduced by disposing of the back surface stripping/cleaning mechanism utilizing spin rotation of the spin chucks 105 and 106 each having a rotation mechanism and the front surface stripping/cleaning mechanism utilizing a chemical high pressure spray, both of which are conventional techniques.

According to a resist stripping apparatus of the present invention, since stripping the resist on the plurality of substrates held in the substrate holding vessel is performed in a batch processing mode, no great reduction in processing capability (facility capability) is caused by rate determination of a processing time performed in a single wafer processing mode. Thus, the processing capability (facility capability) is largely improved by the collective processing of the present invention, as an advantage of the batch processing mode. Also, with the batch processing mode adopted in the substitute liquid replacement processing, the resist stripping capability can provide an effect equal to that achieved with the single wafer processing mode.

Furthermore, in a conventional process, there arose a necessity for installation of a back rinse wafer fixing chuck and a rotation mechanism with a chemical high pressure spray in plural number, while in the resist stripping process of the present invention, an excellent effect is exerted that the installation space for the facilities can be greatly reduced because of installed equipment in single piece.

An apparatus and process for stripping resist of the present invention are applied to substrates for semiconductor, liquid crystal or the like, while the apparatus and process can also be applied in each of cases of removal of various kinds of coated films in a batch processing mode.

1. A resist stripping apparatus comprising:
a substrate holding vessel capable of holding a plurality of substrates;
a stripping bath for accommodating the substrate holding vessel;
a chemical feed unit for feeding a chemical to the stripping bath;
a chemical discharge unit for discharging the chemical from the stripping bath; and
at least one chemical spray nozzle for jetting the chemical to the substrates held in the substrate holding vessel.

2. The resist stripping apparatus according to claim 1, wherein the chemical is isopropyl alcohol.

3. The resist stripping apparatus according to claim 1, wherein the chemical is pure water.

4. The resist stripping apparatus according to claim 1, further comprising a substrate rotating unit for rotating the substrates held in the substrate holding vessel.

5. The resist stripping apparatus according to claim 1, further comprising a second chemical feed unit for feeding the chemical discharged from the chemical discharge unit to the chemical spray nozzle.

6. The resist stripping apparatus according to claim 1, wherein the substrates are semiconductor substrates.

7. The resist stripping apparatus according to claim 1, wherein the substrates are compound semiconductor substrates.

8. The resist stripping apparatus according to claim 1, wherein the chemical spray nozzle jets the chemical to the substrates under high pressure.

9. The resist stripping apparatus according to claim 1, wherein the chemical spray nozzle can move over the plurality of substrates held in the substrate holding vessel.

10. A resist stripping apparatus comprising:
a substrate holding vessel capable of holding a plurality of substrates;
a stripping bath for accommodating the substrate holding vessel;
a chemical feed unit for feeding a chemical to the stripping bath;
a chemical discharge unit for discharging the chemical from the stripping bath; and
at least one chemical spray nozzle for jetting the chemical to the substrates held in the substrate holding vessel, wherein
the chemical spray nozzle jets the chemical to the substrates under high pressure, and is capable of moving over the plurality of substrates held in the substrate holding vessel.

11. The resist stripping apparatus according to claim 10, further comprising a substrate rotating unit for rotating the substrates held in the substrate holding vessel.

12. A resist stripping process, comprising the steps of:
accommodating in a stripping bath a substrate holding vessel holding a plurality of substrates therein;
feeding a chemical into the stripping bath, and immersing the substrate holding vessel and the substrates therein;
discharging the chemical from the stripping bath; and
jetting the chemical to the substrates through a chemical spray nozzle.

13. The resist stripping process according to claim 12, wherein the chemical is isopropyl alcohol.

14. The resist stripping process according to claim 12, wherein the chemical is pure water.

15. The resist stripping process according to claim 12, wherein the substrates are rotated in the substrate holding vessel, in the step of jetting the chemical to the substrates.

16. The resist stripping process according to claim 12 or 15, wherein the substrates are semiconductor substrates.

17. The resist stripping process according to claim 12, wherein the substrates are compound semiconductor substrates.

18. The resist stripping process according to claim 12, wherein the chemical is jetted obliquely to both surfaces of the substrates under high pressure.

19. The resist stripping process according to claim 12, wherein the chemical is jetted to the substrates while the chemical spray nozzle moves over the plurality of substrates.

20. A resist stripping process, comprising the steps of:
accommodating in a stripping bath a substrate holding vessel holding a plurality of substrates therein;
feeding a chemical into the stripping bath, and immersing the substrate holding vessel and the substrates therein;
discharging the chemical from the stripping bath; and
jetting the chemical obliquely to both surfaces of the substrates under high pressure through a chemical spray nozzle while the chemical spray nozzle moves over the plurality of substrates.

21. The resist stripping process according to claim 20, wherein the substrates are rotated in the substrate holding vessel, in the step of jetting the chemical to the substrates.
